(19) United States
(12) Patent Application Publication
(10) Pub. No.: US 2005/0047592 A1
(43) Pub. Date: Mar. 3, 2005

(54) Single-round enciphering apparatus and method using a reduced number of elements in a mobile communication system

(76) Inventor: Jong-Su Lim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/931,037

(22) Filed: Sep. 1, 2004

(30) Foreign Application Priority Data
Sep. 2, 2003 (KR) 2003-61160

(51) Int. Cl. H04L 9/00

(52) U.S. Cl. 380/28; 380/37

(57) ABSTRACT

An enciphering apparatus and method divide an input bit stream with length 2n into first and second sub-bit streams with length n, perform an enciphering procedure, and output an enciphered bit stream with length 2n in a mobile communication system. A first encipherer enciphers the first sub-bit stream by code KLi to output a firstbit stream with length n, or enciphers a second enciphered bit stream by code KLi to output a third bit stream with length n. A second encipherer enciphers the first bit stream by code KOi and code KIi to output a fourth bit stream with length n, or enciphers the first sub-bit stream by code KOi and code KIi to output the second enciphered bit stream with length n, the second encipherer including two sub-enciphering blocks and register. Registers match synchronization of an operation delay caused by the second encipherer for the second sub-bit stream.

### PRIORITY

This application claims the benefit under 35 U.S.C. § 119(a) to an application entitled “Single-Round Enciphering Apparatus and Method Using Minimized Number of Elements in a Mobile Communication System” filed in the Korean Intellectual Property Office on Sep. 2, 2003 and assigned Serial No. 2003-61160, the entire contents of which are incorporated herein by reference.

### BACKGROUND OF THE INVENTION

1. Field of the Invention

The present invention relates generally to a mobile communication system. In particular, the present invention relates to a single-round enciphering apparatus and method using a reduced number of elements.

2. Description of the Related Art

As analog first generation (1G) communication systems evolved into digital second generation (2G) communication systems, mobile communication service provides proposed advanced enciphering methods in order to securely provide a large volume of data at high speed. In this context, third generation (3G) communication systems provide a mobile communication service using a communication data enciphering method for voice signal and multimedia service and a user identifier-based enciphering method in user authentication and radio interface for a mobile terminal.

In a 3^{rd} Generation Project Partnership (3GPP) Universal Mobile Telecommunications System (UMTS) mobile communication system based on a Global System for Mobile communication (GSM) core network, the use of 11 security-related algorithms called Security Structure f0˜f10 is under discussion. Among others, an f8 function for an enciphering algorithm used for data enciphering and deciphering and an f9 function for an integrity algorithm for determining whether a current mobile terminal accesses data have been defined. There is a Kasumi algorithm which is an operation algorithm used for performing the f8 function and the f9 algorithm.

The Kasumi algorithm is a core algorithm recently defined in a block enciphering system based on a MISTY algorithm developed by Mitsubishi Electric of Japan.

The Kasumi algorithm is a block enciphering system having an 8-round Feistel structure, and the enciphering system receives a 64-bit plaintext and outputs a 64-bit ciphertext after 8 enciphering rounds. Here, the “plaintext” refers to a plain data text that a transmission side desires to transmit to a reception side, and the “ciphertext” refers to a security communication text acquired by enciphering the plain data text with an enciphering key, and the ciphertext cannot be accessed by unauthorized users.

FIG. 1 is a block diagram illustrating a hardware structure of a Kasumi enciphering block according to the prior art. Referring to FIG. 1, the Kasumi enciphering block is an enciphering block system with an 8-round Feistel structure, and the enciphering system receives a 64-bit plaintext and outputs a 64-bit ciphertext after 8-round enciphering. Here, the “Feistel structure” refers to a system for dividing a 2n-bit input signal into an n-bit L0 signal and an n-bit R0 signal, and performing 8-round enciphering/deciphering on the n-bit L0 signal and the n-bit R0 signal through corresponding enciphering blocks, and full spreading is achieved through a 2-round operation. Therefore, the Kasumi enciphering algorithm has a high processing speed. More specifically, in the Kasumi enciphering algorithm, the 64-bit input signal is divided into a 32-bit L0 signal and a 32-bit R0 signal before being enciphered. The 32-bit L0 signal and the 32-bit R0 signal are enciphered by enciphering keys KIi (1≦i≦8), KLi (1≦i≦8) and KOi (1≦i≦8) provided from a plurality of FLi encipherers (1≦i≦8) 110, 120, 130, 140, 150, 160, 170 and 180, and a plurality of FOi encipherers (1≦i≦8) 210, 220, 230, 240, 250, 260, 270 and 280 via a key scheduler (not shown), outputting a 64-bit ciphertext.

More specifically, in a first enciphering round, a received 32-bit L0 signal is enciphered by a first first-enciphering key KL1 in the first FL encipherer 110, outputting a ciphertext L01. The ciphertext L01 is enciphered by a first second-enciphering key KO1 and a first third-enciphering key KI1 in the first FO encipherer 210, outputting a 32-bit ciphertext L02. The ciphertext L02 is exclusive-ORed (XORed) with a received 32-bit R0 signal, outputting a 64-bit first enciphered L1 signal.

In a second enciphering round, the first enciphered L1 signal is enciphered by a second second-enciphering key KO2 and a second third-enciphering key KL2 in the second FO encipherer 220, outputting a 32-bit ciphertext L11. The ciphertext L11 is enciphered by a second first-enciphering key KL2 in the second FL encipherer 120, outputting a ciphertext L12. The ciphertext L12 is XORed with the received 32-bit L0 (R1) signal, outputting a 64-bit second enciphered L2 signal.

That is, the Kasumi algorithm receives a 64-bit plaintext and finally outputs a 64-bit ciphertext L8//R8 after performing 8-round enciphering.

FIG. 2 is a detailed block diagram illustrating the FOi encipherer of FIG. 1. Referring to FIG. 2, the FOi encipherer refers to an ith FO encipherer, and the FOi encipherer comprises a plurality of FIi,j sub-encipherers (1≦i≦3 and 1≦j≦3) for performing 3-round enciphering. Herein, a first FO encipherer will be described by way of example. A 32-bit input signal is divided into a 16-bit L0 signal and a 16-bit R0 signal.

The 16-bit L0 signal is XORed with a 16-bit sub-enciphering key KO1,1, outputting an L1 signal. The L1 signal is enciphered by a 16-bit first sub-enciphering key KI1,1 in a FI1,1 sub-encipherer 201, outputting an L1D signal. The 16-bit R0 (=R1) signal is XORed with the L1D signal, outputting an R2 signal.

The 16-bit R1 signal is XORed with a 16-bit sub-enciphering key KO1,2, outputting an L2 signal. The L2 signal is enciphered by a second sub-enciphering key KI1,2 in a FI1,2 sub-encipherer 203, outputting an L2D signal. The 16-bit R2 signal is XORed with the L2D signal, outputting an R3 signal.

The 16-bit R2 signal is XORed with a 16-bit sub-enciphering key KO1,3, outputting an L3 signal. The L3 signal is enciphered by a third sub-enciphering key KI1,3 in a FI1,3 sub-encipherer 205, outputting an L3D signal. The 16-bit R2 signal is XORed with the L3D signal, outputting an R3 signal. The R3 signal is output as an L3 signal.

Therefore, the first FO encipherer 210 receives a 32-bit input signal and outputs a 32-bit ciphertext (or enciphered signal) L3//R3 through 3-round enciphering.

FIG. 3 is a detailed block diagram illustrating the FIi,j sub-encipherer of

FIG. 2. Referring to FIG. 3, the FIi,j sub-encipherer receives a 16-bit input signal, divides the 16-bit input signal into a 9-bit RL0 signal and a 7-bit RR0 signal, and provides the divided signals to sub-enciphering operators. A first SBox9 operator (hereinafter referred to as an “S91 operator”) 310 receives the 9-bit RL0 signal, applies the received 9-bit RL0 signal to Equation (1) shown below, and outputs a signal of 9 bits Y0, Y1, . . . , Y8.
y0=x0x2⊕x3⊕x2x5⊕x5x6⊕x0x7⊕x1x7⊕x7⊕x4x8⊕x5x8⊕x7x8⊕1
y1=x1⊕x0x1⊕x2x3⊕x0x4⊕x1x4⊕x0x5⊕x3x5⊕x6⊕x1x7⊕x2x7⊕x5x8⊕1
y2=x1⊕x0x3⊕x3x4⊕x0x5⊕x2x6⊕x3x6⊕x5x6⊕x4x7⊕x5x7⊕x6x7⊕x8⊕x0x8⊕1
y3=x0⊕x1x2⊕x0x3⊕x2x4⊕x5⊕x0x6⊕x1x6⊕x4x7⊕x0x8⊕x1x8⊕x7x8
y4=x0x1⊕x1x3⊕x4⊕x0x5⊕x3x6⊕x0x7⊕x6x7⊕x1x8⊕x2x8⊕x3x8
y5=x2⊕x1x4⊕x4x5⊕x0x6⊕x1x6⊕x3x7⊕x4x7⊕x6x7⊕x5x8⊕x6x8⊕x7x8⊕1
y6=x0⊕x2x3⊕x1x5⊕x2x5⊕x4x5⊕x3x6⊕x4x6⊕x5x6⊕x7⊕x1x8⊕x3x8⊕x5x8⊕x7x8
y7=x0x1⊕x0x2⊕x1x5⊕x3⊕x0x3⊕x2x3⊕x4x5⊕x2x6⊕x3x6⊕x2x7⊕x5x7⊕x8⊕1
y8=x0x1⊕x2⊕x1x2⊕x3x4⊕x1x5⊕x2x5⊕x1x6⊕x4x6⊕x7⊕x2x8⊕x3x8 (1)

A first ZE operator 320 receives the 7-bit RR0 signal, adds 2 zero (0) bits to the most significant bit (MSB) thereof, and outputs a 9-bit signal. The 9-bit output signal of the S91 operator 310 is XORed with the 9-bit output signal of the first ZE operator 320, outputting a 9-bit RL1 signal.

A first TR operator 330 removes 2 zero bits from the 9-bit RL1 signal and outputs a 7-bit signal. A first SBox7 operator (hereinafter referred to as an “S71 operator”) 340 receives the 7-bit RR0 (=RR1) signal, applies the received 7- bit RR1 signal to Equation (2), and outputs a signal of 7 bits Y0, Y1, . . . , Y6.
y0=x1x3⊕x4⊕x0x1x4⊕x5⊕x2x5⊕x3x4x5⊕x6⊕x0x6⊕x1x6⊕x3x6⊕x2x4x6⊕x1x5x6⊕x4x5x6
y1=x0x1⊕x0x4⊕x2x4⊕x5⊕x1x2x5⊕x0x3x5⊕x6⊕x0x2x6⊕x3x6⊕x4x5x6⊕1
y2=x0⊕x0x3⊕x2x3⊕x1x2x4⊕x0x3x4⊕x1x5⊕x0x2x5⊕x0x6⊕x0x1x6⊕x2x6⊕x4x6⊕1
y3=x1⊕x0x1x2⊕x1x4⊕x3x4⊕x0x5⊕x0x1x5⊕x2x3x5⊕x1x4x5⊕x2x6⊕x1x3x6
y4=x0x2⊕x3⊕x1x3⊕x1x4⊕x0x1x4⊕x2x3x4⊕x0x5⊕x1x3x5⊕x0x4x5⊕x1x6⊕x3x6⊕x0x3x6⊕x5x6⊕1
y5=x2⊕x0x2⊕x0x3⊕x1x2x6⊕x0x2x4⊕x0x5⊕x2x5⊕x4x5⊕x1x6⊕x1x2x6⊕x0x3x6⊕x3x4x6⊕x2x5x6⊕1
y6=x1x2⊕x0x1x3⊕x0x4⊕x1x5⊕x3x5⊕x6⊕x0x1x6⊕x2x3x6⊕x1x4x6⊕x0x5x6 (2)

The 7-bit output signal of the first TR operator 330 is XORed with the 7-bit output signal of the S71 operator 340, and enciphered by a first sub-enciphering key KI1,1,1, outputting a 7-bit RR2 signal. The RL1 signal is XORed with a second 9-bit sub-enciphering key KI1,1,2, outputting a 9-bit RL2 signal.

A second SBox9 operator (hereinafter referred to as an “S92 operator”) 350 receives the 9-bit LR2 signal, applies the received 9-bit RL2 signal to Equation (1), and outputs a signal of 9 bits Y0, Y1, . . . , Y8. A second ZE operator 360 receives the 7-bit RR2 signal, adds 2 zero bits to MSB thereof, and outputs a 9-bit signal. The 9-bit output signal of the S92 operator 350 is XORed with the 9-bit output signal of the second ZE operator 360, outputting a 9-bit RL3 signal.

A second TR operator 370 removes 2 zero bits from the 9-bit RL3 signal and outputs a 7-bit signal. A second SBox7 operator (hereinafter referred to as an “S72 operator”) 380 receives the 7-bit RR2 (=RR3) signal, applies the received 7-bit RR3 signal to Equation (2), and outputs a signal of 7 bits Y0, Y1, . . . , Y6. The 7-bit output signal of the second TR operator 370 is XORed with the 7-bit output signal of the S72 operator 380, outputting a 7-bit RR4 signal.

Therefore, the FIi,j sub-encipherer enciphers the 9-bit RL3 (=RL4) signal and the 7-bit RR4 signal, and outputs a 16-bit ciphertext RL4//RR4.

As described above, a 16-bit signal input to the FIi,j sub-encipherer sequentially undergoes logical operations and XOR operations through a plurality of operators for a predetermined clock cycle. That is, each of the operators generates gate delay and routing delay caused by the logical operations and XOR operations. Therefore, if no operation is performed for the predetermined clock cycle, an enciphering operation of the entire system fails undesirably. In addition, because of the accumulated gate delay and routing delay, an operation speed of the entire enciphering system is reduced undesirably.

Therefore, embodiments of the present invention provide an apparatus and method for improving an internal operation speed by performing operations for a predetermined clock cycle, in implementing the Kasumi algorithm. To accomplish this, the embodiments of the present invention provide an apparatus and method for increasing the efficiency of the entire enciphering system by dividing an encipherer into two sub-operation blocks.

### SUMMARY OF THE INVENTION

It is, therefore, an object of the present invention to provide an enciphering apparatus for receiving an input bit stream with a length 2n and finally outputting an enciphered bit stream with a length 2n using a reduced number of elements in a mobile communication system.

It is another object of the present invention to provide an enciphering method for receiving an input bit stream with a length 2n and finally outputting an enciphered bit stream with a length 2n using a reduced number of elements in a mobile communication system.

It is further another object of the present invention to provide an apparatus and method for iteratively performing an enciphering operation on a single-round basis.

In accordance with one aspect of the present invention, there is provided an enciphering apparatus for dividing an input bit stream with a length 2n into a first sub-bit stream with a length n and a second sub-bit stream with a length n, performing an enciphering operation according to an enciphering procedure, and finally outputting an enciphered bit stream with a length 2n in a mobile communication system. The apparatus comprises a first encipherer for enciphering the first sub-bit stream by a first enciphering code KLi to output a first enciphered bit stream with a length n, or enciphering a second enciphered bit stream by the first enciphering code KLi to output a third enciphered bit stream with a length n; a second encipherer for enciphering the first enciphered bit stream by a second enciphering code KOi and a third enciphering code KIi to output a fourth enciphered bit stream with a length n, or enciphering the first sub-bit stream by the second enciphering code KOi and the third enciphering code KIi to output the second enciphered bit stream with a length n, the second encipherer including two sub-enciphering blocks and a register; and a plurality of first registers for matching synchronization of an operation delay caused by an operation of the second encipherer for the second sub-bit stream.

In accordance with another aspect of the present invention, there is provided an enciphering method for dividing an input bit stream with a length 2n into a first sub-bit stream with a length n and a second sub-bit stream with a length n, performing an enciphering operation according to an enciphering procedure, and finally outputting an enciphered bit stream with a length 2n in a mobile communication system. The method comprising the steps of enciphering, by a first encipherer, the first sub-bit stream by a first enciphering code KLi provided from a scheduler to output a first enciphered bit stream with a length n, or enciphering a second enciphered bit stream with a length n, output from a second encipherer, by the first enciphering code KLi to output a third enciphered bit stream with a length n; enciphering, by the second encipherer, the first enciphered bit stream by a second enciphering code KOi and a third enciphering code KIi to output a fourth enciphered bit stream with a length n, or enciphering the first sub-bit stream by the second enciphering code KOi and the third enciphering code KIi to output the second enciphered bit stream with a length n, the second encipherer including two sub-enciphering blocks and a second register; and matching, by a plurality of first registers, synchronization of an operation delay caused by an operation of the second encipherer including the two sub-enciphering blocks and the second register.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a hardware structure of a Kasumi enciphering block according to the prior art;

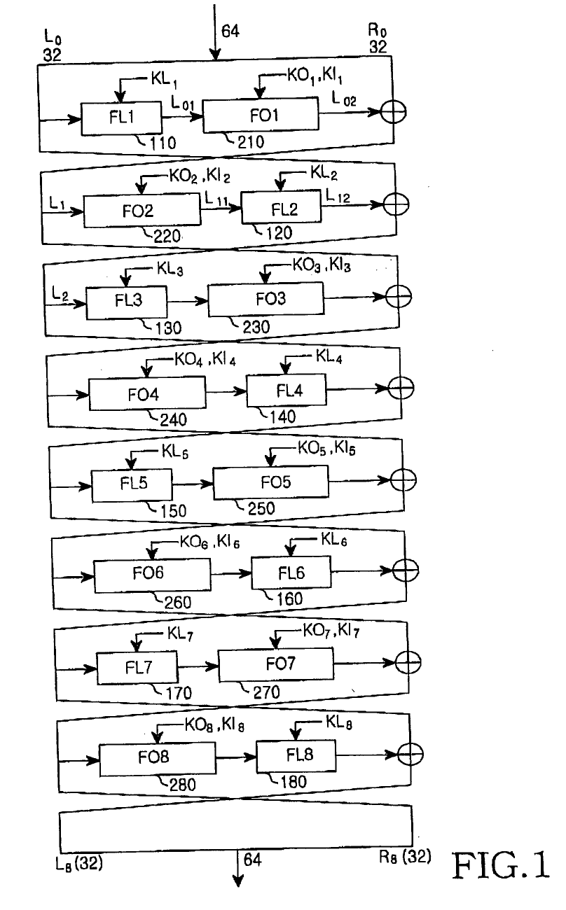

FIG. 2 is a detailed diagram illustrating the FOi encipherer of FIG. 1;

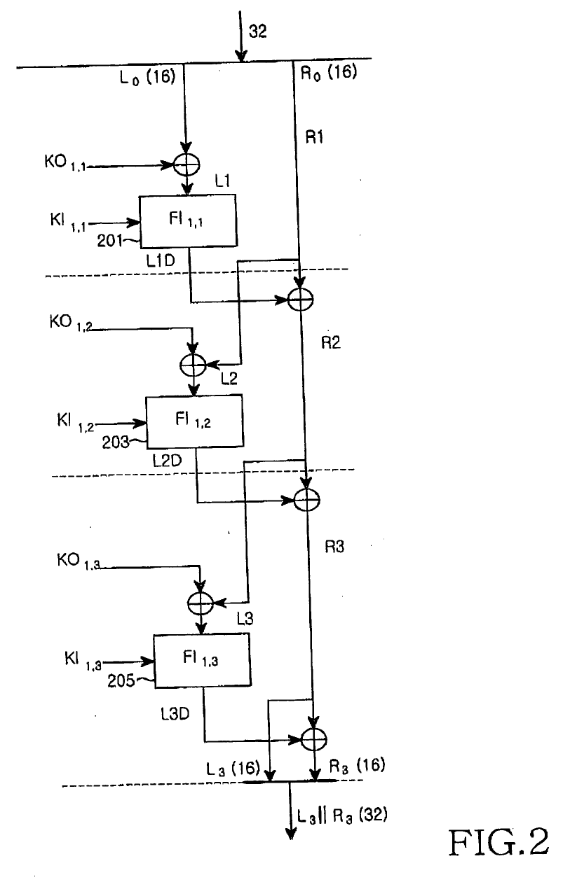

FIG. 3 is a detailed diagram illustrating the FIi,j sub-encipherer of FIG. 2;

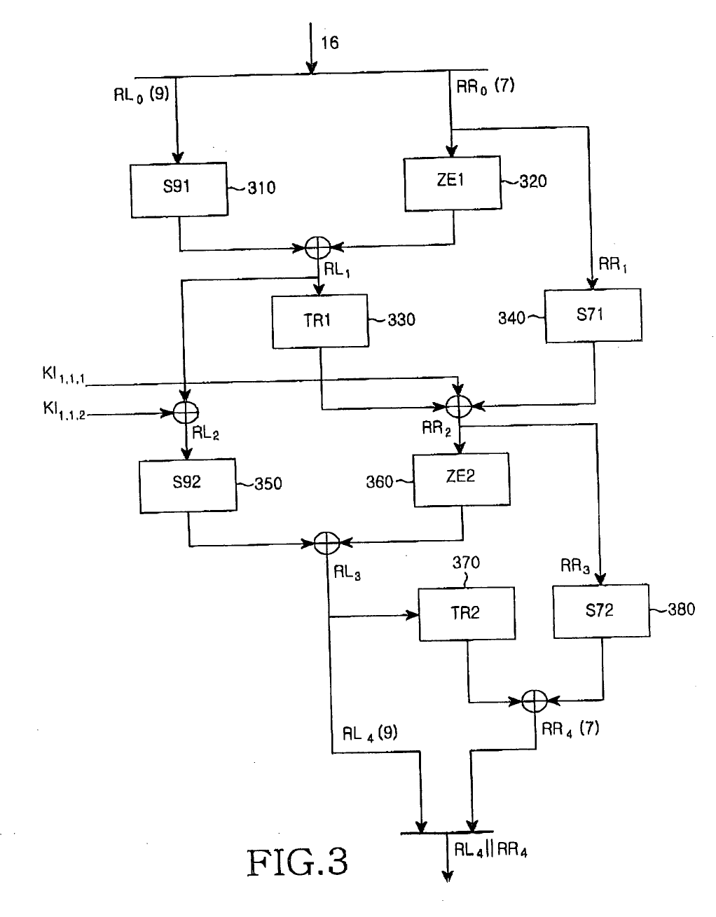

FIG. 4 is a diagram illustrating a structure of a FIi,j sub-encipherer according to an embodiment of the present invention;

FIG. 5 is a detailed diagram illustrating a FOi encipherer according to an embodiment of the present invention;

FIG. 6 is a diagram illustrating a hardware structure of the FOi encipherer of FIG. 5 according to an embodiment of the present invention; and

FIG. 7 is a diagram illustrating a hardware structure of a Kasumi enciphering block according to an embodiment of the present invention.

Throughout the drawings, it should be noted that the same or similar elements are denoted by like reference numerals.

### DETAILED DESCRIPTION OF THE PREFERRED EMBODIMENT

An embodiment of the present invention will now be described in detail with reference to the annexed drawings. In the following description, a detailed description of known functions and configurations incorporated herein has been omitted for conciseness.

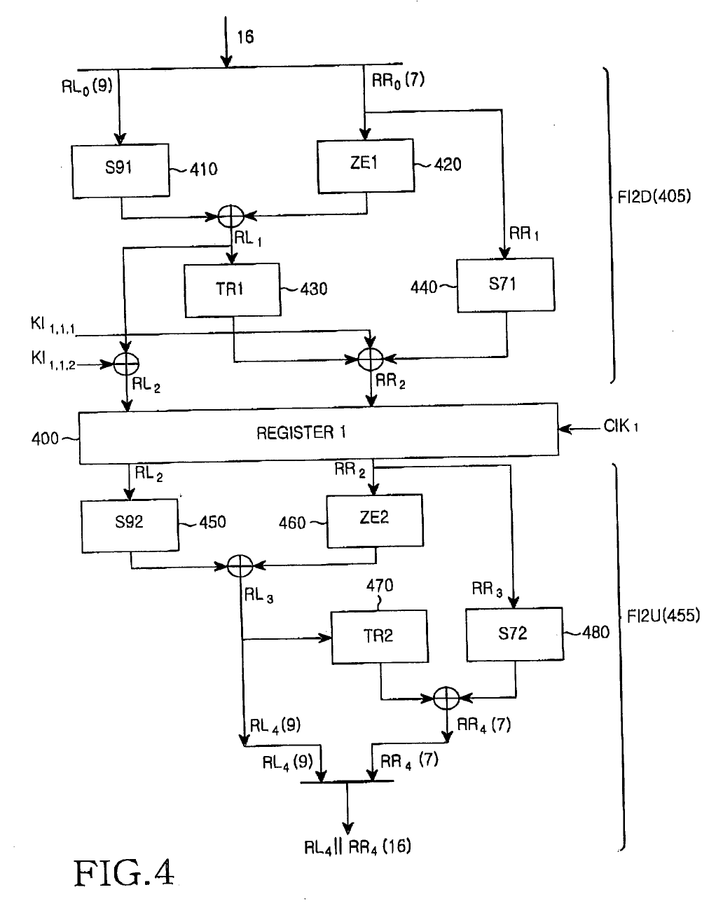

FIG. 4 is a block diagram illustrating a structure of a FIi,j sub-encipherer according to an embodiment of the present invention. Referring to FIG. 4, the new FIi,j sub-encipherer is characterized in that one encipherer is divided into two sub-operation (or sub-enciphering) blocks and the number of operators needed for an enciphering operation for a predetermined clock cycle is reduced. That is, in order to reduce a gate delay caused by gate operations performed for a predetermined clock cycle, the FIi,j sub-encipherer is divided into two sub-operation blocks. A flip-flop is added between the two sub-operation blocks to match clock synchronization between the blocks so that they output the same result values in response to a predetermined clock signal.

A first sub-operation (or sub-enciphering) block FI2D divides a 16-bit input signal into a 9-bit RL0 signal and a 7-bit RR0 signal. A first SBox9 operator (hereinafter referred to as an “S91 operator”) 410 receives, the 9-bit RL0 signal, applies the received 9-bit RL0 signal to Equation (3) shown below, and outputs a signal of 9 bits Y0, Y1, . . . , Y8.
y0=x0x2⊕x3⊕x2x5⊕x5x6⊕x0x7⊕x1x7⊕x2x7⊕x4x8⊕x5x8⊕x7x8⊕1
y1=x1⊕x0x1⊕x2x3⊕x0x4⊕x1x4⊕x0x5⊕x3x5⊕x6⊕x1x7⊕x2x7⊕x5x8⊕1
y2=x1⊕x0x3⊕x3x4⊕x0x5⊕x5x6⊕x3x6⊕x5x6⊕x4x7⊕x5x7⊕x6x7⊕x8⊕x0x8⊕1
y3=x0⊕x1x2⊕x0x3⊕x2x4⊕x5⊕x0x6⊕x1x6⊕x4x7⊕x0x8⊕x1x8⊕x7x8
y4=x0x1⊕x1x3⊕x4⊕x0x5⊕x3x6⊕x0x7⊕x6x7⊕x1x8⊕x2x8⊕x3x8
y5=x2⊕x1x4⊕x4x5⊕x0x6⊕x1x6⊕x3x7⊕x4x7⊕x6x7⊕x5x8⊕x6x8⊕x7x8⊕1
y6=x0⊕x2x3⊕x1x5⊕x2x5⊕x4x5⊕x3x6⊕x4x6⊕x5x6⊕x7⊕x1x8⊕x3x8⊕x5x8⊕x7x8
y7=x0x1⊕x0x2⊕x1x2⊕x3⊕x0x3⊕x2x3⊕x4x5⊕x2x6⊕x3x6⊕x5x7⊕5x7⊕x8⊕1
y8=x0x1⊕x2⊕x1x2⊕x3x4⊕x1x5⊕x2x5⊕x1x6⊕x4x6⊕x7⊕x2x8⊕x3x8 (3)

A first ZE operator 420 receives the 7-bit RR0 signal, adds 2 zero (0) bits to the most significant bit (MSB) thereof, and outputs a 9-bit signal. The 9-bit output signal of the S91 operator 410 is XORed with the 9-bit output signal of the first ZE operator 420, outputting a 9-bit RL1 signal.

A first TR operator 430 removes 2 zero bits from the 9-bit RL1 signal and outputs a 7-bit signal. A first SBox7 operator (hereinafter referred to as an “S71 operator”) 440 receives the 7-bit RR0 (=RR1) signal, applies the received 7-bit RR1 signal to Equation (4) shown below, and outputs a signal of 7 bits Y0, Y1, . . . , Y6.
y0=x1x3⊕x4⊕x0x1x4⊕x5⊕x2x5⊕x3x4x5⊕6⊕x0x6⊕x1x6⊕x3x6⊕x2x4x6⊕x1x5x6⊕x4x5x6
y1=x0x1⊕x0x4⊕x2x4⊕x5⊕x1x2x5⊕x0x3x5⊕x6⊕x0x2x6⊕x3x6⊕x4x5x6⊕1
y2=x0⊕x0x3⊕x2x3⊕x1x2x4⊕x0x3x4⊕x1x5⊕x0x2x5⊕x0x6⊕x0x1x6⊕x2x6⊕x4 6⊕1
y3=x1⊕x0x1 2⊕x1x4⊕x3x4⊕x0x5⊕x0x1x5⊕x2x3x5⊕x1x4x5⊕x2x6⊕x1x3x6
y4=x0x2⊕x3⊕x1x3⊕x1x4⊕x0x1x4⊕x2x3x4⊕x0x5⊕x1x3x5⊕x0x4x5⊕x1x6⊕x3x6⊕x0x3x6⊕x5x6⊕1
y5=x2⊕x0x2⊕x0x3⊕x1x2x3⊕x0x2x4⊕x0x5⊕x2x5⊕x4x5⊕x1x6⊕x1x2x6⊕x0x3x6⊕x3x4x6⊕x2x5x6⊕1
y6=x1x2⊕x0x1x3⊕x0x4⊕x1x5⊕x3x5⊕x6⊕x0x1x6⊕x2x3x6⊕x1x4x6⊕x0x5x6 (4)

The 7-bit output signal of the first TR operator 430 is XORed with the 7-bit output signal of the S71 operator 440, and enciphered by a first sub-enciphering key KI1,1,1, outputting a 7-bit RR2 signal. The RL1 signal is XORed with a second 9-bit sub-enciphering key KI1,1,2, outputting a 9-bit RL2 signal. The 9-bit RL2 signal and the 7-bit RR2 signal are output to a register 400.

Upon receiving a clock signal from a controller (not shown), the register 400 outputs the 9-bit RL2 signal and the 7-bit RR2 signal to a second sub-operation (or sub-enciphering) block FI2U. That is, in response to a clock signal received from the controller, a second sub-enciphering operation is initiated.

A second SBox9 operator (hereinafter referred to as an “S92 operator”) 450 receives the 9-bit LR2 signal, applies the received 9-bit RL2 signal to Equation (3), and outputs a signal of 9 bits Y0, Y1, . . . , Y8. A second ZE operator 460 receives the 7-bit RR2 signal, adds 2 zero bits to MSB thereof, and outputs a 9-bit signal. The 9-bit output signal of the S92 operator 450 is XORed with the 9-bit output signal of the second ZE operator 460, outputting a 9-bit RL3 signal.

A second TR operator 470 removes 2 zero bits from the 9-bit RL3 signal and outputs a 7-bit signal. A second SBox7 operator (hereinafter referred to as an “S72 operator”) 480 receives the 7-bit RR2 (=RR3) signal, applies the received 7-bit RR3 signal to Equation (4), and outputs a signal of 7 bits Y0, Y1, . . . , Y6. The 7-bit output signal of the second TR operator 470 is XORed with the 7-bit output signal of the S72 operator 480, outputting a 7-bit RR4 signal.

Therefore, the FIi,j sub-encipherer enciphers the 9-bit RL3 (=RL4) signal and the 7-bit RR4 signal, and outputs an 16-bit ciphertext RL4//RR4.

In this manner, the required number of gates in the sub-operation blocks that must perform enciphering operations for a predetermined clock cycle is reduced, thereby preventing a decrease in operation speed caused by a gate delay. Although the use of a separate register causes an internal one-clock delay, this is relatively smaller than a gate delay caused by an enciphering operation through one FIi,j sub-encipherer, thereby contributing to an accurate and fast enciphering operation.

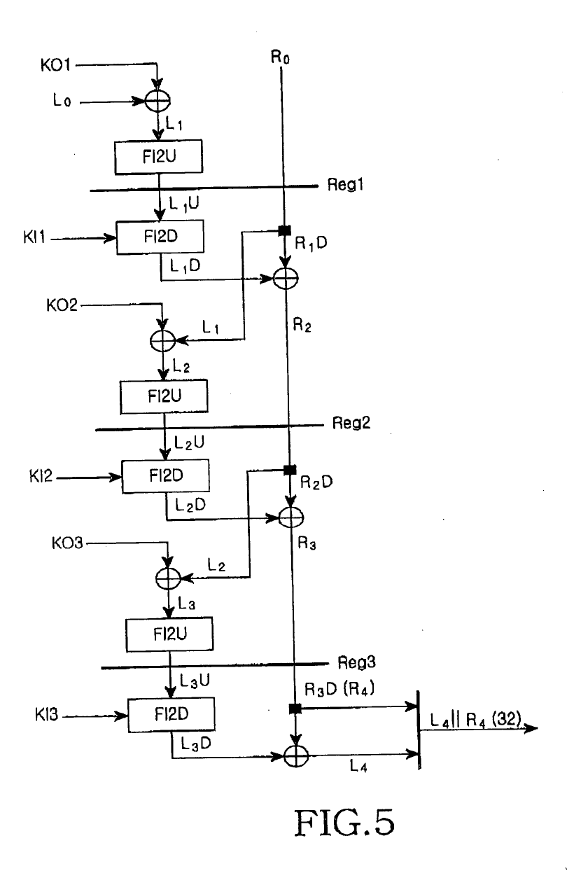

FIG. 5 is a detailed block diagram illustrating a FOi encipherer according to an embodiment of the present invention. Referring to FIG. 5, the FOi encipherer refers to an i^{th} FO encipherer, and the FOi encipherer comprises a plurality of FIi,j sub-encipherers (1≦i≦3 and 1≦j≦3) for performing 3-round enciphering. Herein, a first FO encipherer will be described by way of example. The FIi,j sub-encipherers correspond to the FIi,j sub-encipherer of FIG. 4 in which a separate register is provided between two sub-operation blocks.

A received 16-bit L0 signal is XORed with a 16-bit sub-enciphering key KO1, outputting an L1 signal. The L1 signal is input to a first FI2U sub-operation block of a FI1,1 sub-encipherer, and the first FI2U sub-operation block enciphers the L1 signal and outputs an L1U signal. The L1U signal is temporarily stored in a first register. Also, a received 16-bit R0 signal is temporarily stored in the first register. The first register outputs a 32-bit L1U//R0(R1D) signal in response to a clock signal received from a controller (not shown). The 16-bit L1U signal is enciphered by a sub-enciphering key KI1,1,1 and a sub-enciphering key KI1,1,2 in a second FI2D sub-operation block of the FI1,1 sub-encipherer, outputting an L1D-signal. The L1D signal is XORed with the R0 (=R1D) signal, outputting an R2 signal. Further, the R1D (=L1) signal is XORed with a sub-enciphering key K02, outputting an L2 signal.

The L2 signal is input to a first FI2U sub-operation block of a FI1,2 sub-encipherer, and the first FI2U sub-operation block enciphers the L2 signal and outputs an L2U signal. The L2U signal is temporarily stored in a second register. Also, the 16-bit R2 signal is temporarily stored in the second register. The second register outputs a 32-bit L2U//R2(R2D) signal in response to a clock signal received from the controller. The 16-bit L2U signal is enciphered by a sub-enciphering key KI2,1,1 and a sub-enciphering key KI2,1,2 in a second FI2D sub-operation block of the FI1,2 sub-encipherer, outputting an L2D signal. The L2D signal is XORed with the R2D signal, outputting an R3 signal. Further, the R2D (=L2) signal is XORed with a sub-enciphering key K03, outputting an L3 signal.

The L3 signal is input to a first FI2U sub-operation block of a FI1,3 sub-encipherer, and the first FI2U sub-operation block enciphers the L3 signal and outputs an L3U signal. The L3U signal is temporarily stored in a third register. Also, the 16-bit R3 signal is temporarily stored in the third register. The third register outputs a 32-bit L3U//R3(R3D) signal in response to a clock signal received from the controller. The 16-bit L3U signal is enciphered by a sub-enciphering key KI3,1,1 and a sub-enciphering key KI3,1,2 in a second FI2D sub-operation block of the FI1,3 sub-encipherer, outputting an L3D signal. The L3D signal is XORed with the R3D signal, outputting an L4 signal. Further, the R3D signal is output as an R4 signal.

As described above, the FOi encipherer performs enciphering through six sub-operation blocks, and each of the sub-encipherers applies an output signal of its first sub-operation block to its second sub-operation block upon receipt of a clock signal, for an enciphering operation. In this case, a required size of an operation block that must perform enciphering operations for a predetermined clock cycle is reduced, thereby reducing a gate delay caused by the enciphering operations. The reduction in gate delay secures a correct enciphered output signal during enciphering operations by all the sub-encipherers. In addition, the reduction in gate delay contributes to an increase in the entire operation speed.

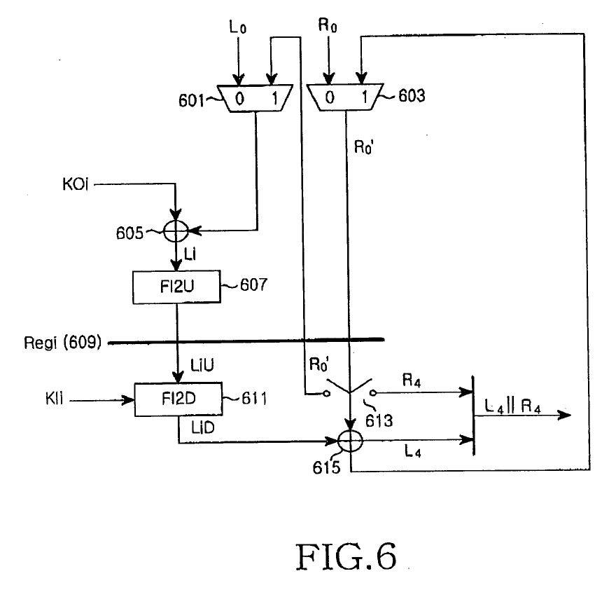

FIG. 6 is a diagram illustrating a hardware structure of the FOi encipherer of FIG. 5 according to an embodiment of the present invention. Referring to FIG. 6, the FOi encipherer comprises multiplexers 601 and 603, logical elements 605 and 615, a first sub-operation block FI2U and a second sub-operation block FI2D. The FOi encipherer refers to an ith FO encipherer, and the FOi encipherer comprises a plurality of FIi,j sub-encipherers (1≦i≦3 and I≦j≦3) for performing 3-round enciphering. That is, the FOi encipherer comprises two sub-operation blocks and a separate register connected therebetween, to iteratively perform a 3-round enciphering operation. Herein, a first FO encipherer will be described by way of example.

A received 16-bit L0 signal is output through the multiplexer 601, and then XORed with a 16-bit sub-enciphering key KO1, outputting an L1 signal. The L1 signal is applied to a first sub-operation block FI2U, and the first sub-operation block FI2U enciphers the L1 signal and outputs an L1U signal. The L1U signal is temporarily stored in a first register 609. A received 16-bit R0 signal is output as an R0′ signal through the multiplexer 603, and then temporarily stored in the first register 609. The first register 609 outputs a 32-bit L1U//R0 (R0′) signal upon receipt of a clock signal. The 16-bit L1U signal is enciphered by a first sub-enciphering key KI1,1,1 and a second sub-enciphering key KI1,1,2 in a second sub-operation block FI2D, outputting an L1D signal. The L1D signal is XORed with the R0′ signal, and then fed back to the multiplexer 603. At the same time, the R0′ is fed back to the multiplexer 601.

In this same method, the FOi encipherer iteratively performs 3-round enciphering through the first sub-operation block FI2U, the second sub-operation block FI2D, and the register 609. By doing so, the number of gate elements that must perform enciphering operations for a predetermined clock cycle is reduced, contributing to an efficient enciphering operation.

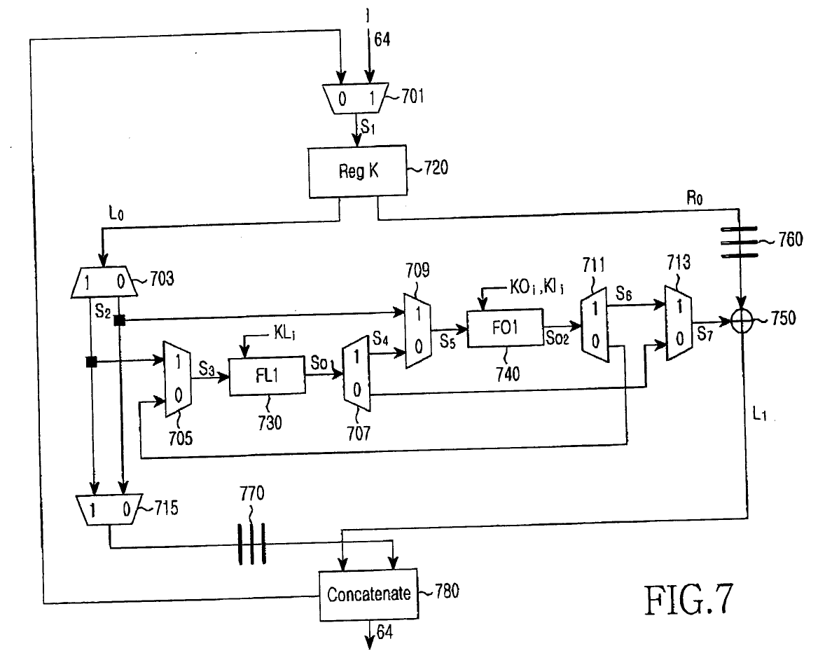

FIG. 7 is a diagram illustrating a hardware structure of a Kasumi enciphering block according to an embodiment of the present invention. Referring to FIG. 7, the Kasumi enciphering block comprises a plurality of multiplexers of a first multiplexer 701, a second multiplexer 703, a third multiplexer 705, a fourth multiplexer 707, a fifth multiplexer 709, a sixth multiplexer 711 and a seventh multiplexer 713, a register K 720, an FL encipherer 730, and an RO encipherer 740. The FO encipherer 740 is identical in structure to the FO encipherer illustrated in FIG. 6. The Kasumi enciphering block performs an enciphering operation according to a control signal and a clock signal provided from a main processor (not shown) that controls the entire system.

A 64-bit input signal is output as an Si signal (or I signal) via the first multiplexer 701, and the S1 signal is applied to the register K 720. The register K 720 divides the S1 signal into a 32-bit L0 signal and a 32-bit R0 signal according to a clock cycle. The L0 signal is output as an S2 signal via the second multiplexer 703, and the S2 signal is output as an S3 signal via the third multiplexer 705. The S3 signal is enciphered with a first enciphering key KLi in the FL encipherer 730, outputting an S01 signal. The S01 signal is output as an S4 signal via the fourth multiplexer 707, and the S4 signal is output as an S5 signal via the fifth multiplexer 709. The S5 signal is enciphered by a second enciphering key KOi and a third enciphering key KIi in the FO encipherer 740, outputting an enciphered signal S02. The FO encipherer 740 includes a first sub-operation block FI2U, a second sub-operation block FI2D, and a separate register interposed therebetween, and performs 3-round sub-enciphering on the S5 signal using the second enciphering key KOi and the third enciphering key KIi, outputting the enciphered signal S02. The S02 signal is output as an S6 signal via the sixth multiplexer 711, and the S6 signal is output as an S7 signal via the seventh multiplexer 713.

The 32-bit R0 signal is delayed through a separate register 760, outputting a delayed R0 signal. The register 760 delays the 32-bit R0 signal by 3 clock cycles in order to XOR the 32-bit R0 signal with the 32-bit enciphered signal S7. The delayed R0 signal is XORed with the S7 signal in a logical element 750, outputting a 64-bit L1 signal. The 64-bit L1 signal is fed back to the first multiplexer 701 via a concatenator 780.

The 64-bit L1 signal is output as an S1 signal via the first multiplexer 701, and then applied to the register K 720. The register K 720 divides the SI signal into a 32-bit L0 signal and a 32-bit R0 signal according to a clock cycle. The L0 signal is output as an S2 signal via the second multiplexer 703, and the S2 signal is output as an S5 signal via the fifth multiplexer 709. The S5 signal is enciphered with the second enciphering key KOi and the third enciphering key KIi in the FO encipherer 704, outputting an enciphered signal S02. As described above, the FO encipherer 740 includes a first sub-operation block FI2U, a second sub-operation block FI2D, and a separate register interposed therebetween, and performs 3-round sub-enciphering on the S5 signal using the second enciphering key KOi and the third enciphering key KIi, outputting the enciphered signal S02. The S02 signal is output as an S6 signal via the sixth multiplexer 711, and the S6 signal is output as an S3 signal via the third multiplexer 705. The S3 signal is enciphered by the first enciphering key KLi in the FL encipherer 730, outputting an S01 signal. The S01 signal is output as an S7 signal via the seventh multiplexer 713.

The 32-bit L0 signal is delayed through the separate register 760, outputting a delayed L0 (R1) signal. The register 760 delays the 32-bit L0 signal by 3 clock cycles in order to XOR the 32-bit L0 signal with the 32-bit enciphered signal S7. The delayed L0 signal is XORed with the S7 signal in the logical element 750, outputting a 64-bit L2 signal. The 64-bit L2 signal is fed back to the first multiplexer 701 via the concatenator 780.

Table 1 illustrates the operation speed and system performance improved by performing enciphering operations using the enciphering algorithm according to an embodiment of the present invention.

TABLE 1

| | Conventional 8-Round | New Single-Round |
|---|---|---|
| | Kasumi Algorithm | Kasumi Algorithm |
| Number of Slices | 3696 chips used | 671 chips used |
| | (39%, /9408) | (7%, /9408) |
| Minimum period | 51.143 ns | 26.659 ns |
| Maximum | 19.553 MHz | 37.511 MHz |
| frequency | | |

That is, the Kasumi enciphering block includes one FL encipherer 730 and one FO encipherer 740 in performing the same enciphering operation as the conventional enciphering algorithm. The use of the FO enciphering block 740 including a first sub-operation block FI2U, a second sub-operation block FI2D and a separate register in the Kasumi enciphering algorithm increases an operation speed for a predetermined clock cycle. In addition, the use of the reduced number of elements contributes to a reduction in power consumption caused by the enciphering operation. Therefore, the efficiency of the entire system is increased.

As can be understood from the foregoing description, the embodiment of the present invention designs an 8-round enciphering algorithm with a single-round enciphering block, thereby reducing the number of elements used for performing an enciphering operation. The reduction in number of elements prevents a possible time delay between the elements. The reduction in the number of elements that must perform an enciphering operation for a predetermined clock cycle increases an operation speed of the entire system and reduces the cost.

While the invention has been shown and described with reference to a certain embodiment thereof, it should be understood by those skilled in the art that various changes in form and details may be made therein without departing from the spirit and scope of the invention as defined by the appended claims.

1. An enciphering apparatus for dividing an input bit stream with a length 2n into a first sub-bit stream with a length n and a second sub-bit stream with a length n, performing an enciphering operation according to an enciphering procedure, and finally outputting an enciphered bit stream with a length 2n in a mobile communication system, the apparatus comprising:
a first encipherer for enciphering the first sub-bit stream by a first enciphering code KLi to output a first enciphered bit stream with a length n, or enciphering a second enciphered bit stream by the first enciphering code KLi to output a third enciphered bit stream with a length n;
a second encipherer for enciphering the first enciphered bit stream by a second enciphering code KOi and a third enciphering code KIi in order to output a fourth enciphered bit stream with a length n, or enciphering the first sub-bit stream by the second enciphering code KOi and the third enciphering code KIi in order to output the second enciphered bit stream with a length n, the second encipherer including two sub-enciphering blocks and a register; and
a plurality of first registers for matching synchronization of an operation delay caused by an operation of the second encipherer for the second sub-bit stream.

2. The enciphering apparatus of claim 1, wherein the second encipherer comprises:
a first sub-operation block for dividing the first enciphered bit stream with a length n into a first sub-enciphered bit stream with a length n/2 and a second sub-enciphered bit stream with a length n/2, enciphering the first sub-enciphered bit stream by a first sub-enciphering key KO1, and sub-enciphering the enciphered output value;
a second register for storing an output value of the first sub-operation block; and
a second sub-operation block for sub-enciphering an output value of the second register by sub-enciphering codes for the third enciphering code KIi.

3. The enciphering apparatus of claim 2, wherein the second register stores an output value of the first sub-operation block according to a clock signal, and outputs an output value of the first sub-operation block to the second sub-operation block according to the clock signal.

4. The enciphering apparatus of claim 1, wherein the number of the first registers is equal to the number of clock cycles delayed by the enciphering operation of the second encipherer.

5. The enciphering apparatus of claim 4, wherein the number of the first registers is equal to the number of 3 clock cycles delayed by the enciphering operation of the second encipherer.

6. An enciphering method for dividing an input bit stream with a length 2n into a first sub-bit stream with a length n and a second sub-bit stream with a length n, performing an enciphering operation according to an enciphering procedure, and finally outputting an enciphered bit stream with a length 2n in a mobile communication system, the method comprising the steps of:
(a) enciphering, by a first encipherer, the first sub-bit stream by a first enciphering code KLi provided from a scheduler to output a first enciphered bit stream with a length n, or enciphering a second enciphered bit stream with a length n, output from a second encipherer, by the first enciphering code KLi to output a third enciphered bit stream with a length n;
(b) enciphering, by the second encipherer, the first enciphered bit stream by a second enciphering code KOi and a third enciphering code KIi to output a fourth enciphered bit stream with a length n, or enciphering the first sub-bit stream by the second enciphering code KOi and the third enciphering code KIi to output the second enciphered bit stream with a length n, the second encipherer including two sub-enciphering blocks and a second register; and
(c) matching, by a plurality of first registers, synchronization of an operation delay caused by an operation of the second encipherer including the two sub-enciphering blocks and the second register.

7. The enciphering method of claim 6, wherein the step (b) comprises the steps of:
dividing, by a first sub-operation block, the first enciphered bit stream with a length n into a first sub-enciphered bit stream with a length n/2 and a second sub-enciphered bit stream with a length n/2, and enciphering the first sub-enciphered bit stream by a first sub-enciphering key KO1;
storing, by the second register, an output value of an enciphering operation by the first sub-operation block; and
sub-enciphering, by a second sub-operation block, an output value of the second register by sub-enciphering codes for the third enciphering code KIi.

8. The enciphering method of claim 7, wherein the second register stores an output value of the first sub-operation block according to a clock signal, and outputs an output value of the first sub-operation block to the second sub-operation block according to the clock signal.

9. The enciphering method of claim 6, wherein the number of the first registers is equal to the number of clock cycles delayed by the enciphering operation of the second encipherer.

10. The enciphering method of claim 9, wherein the number of the first registers is equal to the number of 3 clock cycles delayed by the enciphering operation of the second encipherer.
